(19) United States
(12) Patent Application Publication
(10) Pub. No.: US 2011/0225028 A1
(43) Pub. Date: Sep. 15, 2011

(54) SYSTEM AND METHOD FOR PROVIDING COMMUNICATION WITH AN ADVERTISER FROM AN ELECTRONIC DEVICE

(75) Inventor: Serge RUTMAN, Boulder Creek, CA (US)

(73) Assignee: Skiff LLC, New York, NY (US)

(21) Appl. No.: 12/721,668

(22) Filed: Mar. 11, 2010

(51) Int. Cl. G06Q 30/00; G06F 15/16; G06F 3/048

(52) U.S. Cl. 705/14.4; 709/227; 715/764

(57) ABSTRACT

A system and method for establishing communication between an electronic device and at least one contact associated with electronic content presented at the electronic device. The system and method may comprise a presentation module configured to present electronic content at an electronic device, where the electronic content may be associated with contact information of at least one contact; an interactive module configured to receive at least one user command from an input at the electronic device; and a communication module configured to establish communication between the electronic device and the at least one contact regarding the presented electronic content.

### BACKGROUND INFORMATION

Periodicals often derive significant revenue from advertisers. Advertisements are typically printed in periodicals in order to be seen by potential consumers. Some periodicals strive to increase odds of particular advertisements being viewed by consumers by placing them on the front page, on entire pages, or on inserted sheets that fall out of the periodical. Because statistical correlations exist between advertisement placement, size, and/or design and reader/consumer behavior, odds that an advertisement to be viewed by a consumer may be increased. However, as distribution of traditional paper-based periodical content (e.g., newspapers and magazines) shifts to newer electronic formats (e.g., e-readers and other connected devices), conventional systems and method do not adequately and efficiently provide a technique for presenting advertisements or other content in an electronic device, where the advertisement is capable of directly allowing a user of the electronic device to inquire about the advertised product or service or other similar action. As electronic devices become better equipped with one or more bidirectional communication links (e.g., cellular, data, voice, etc.), a system and method for providing communication with a content provider (e.g., an advertiser) directly from an electronic device may allow a more effective marketing and business solution by appealing to viewers' desire for instant gratification and shortened attention span.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements.

FIG. 1 depicts a block diagram of a system for content distribution, according to an exemplary embodiment.

FIG. 2 depicts a module for presenting interactive content at an electronic device, according to an exemplary embodiment.

FIG. 3A-3B depict content presentment configurations with interactive electronic content at an electronic device, according to exemplary embodiments.

FIG. 4 depicts an illustrative flowchart for presenting interactive electronic content at an electronic device, according to an exemplary embodiment.

FIG. 5 depicts an illustrative flowchart for presenting interactive electronic content at an electronic device, according to an exemplary embodiment.

### DETAILED DESCRIPTION

Certain embodiments of the present invention provide electronic content access management on an electronic display device. More particularly, certain embodiments of the present invention provide a system for and method of managing electronic content access. Such electronic content may be accessed, by way of non-limiting example, via a device utilizing an electronic paper display, such as an electrophoretic display (“EPD”) or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271.

As page real estate begins to shrink to fit smaller electronic paper formats, original content may not adequately scaled to fit within a given electronic page (e.g., image sizes, story sizes, etc.). For example, a full-sized advertisement typically presented in a traditional newspaper would not be able to fit, preserving its actual dimensions and size, within the confines of a much smaller portable handheld electronic device. Therefore, optimizing an electronic page for presenting advertisement content, without significant size alterations or dimension distortions, becomes important.

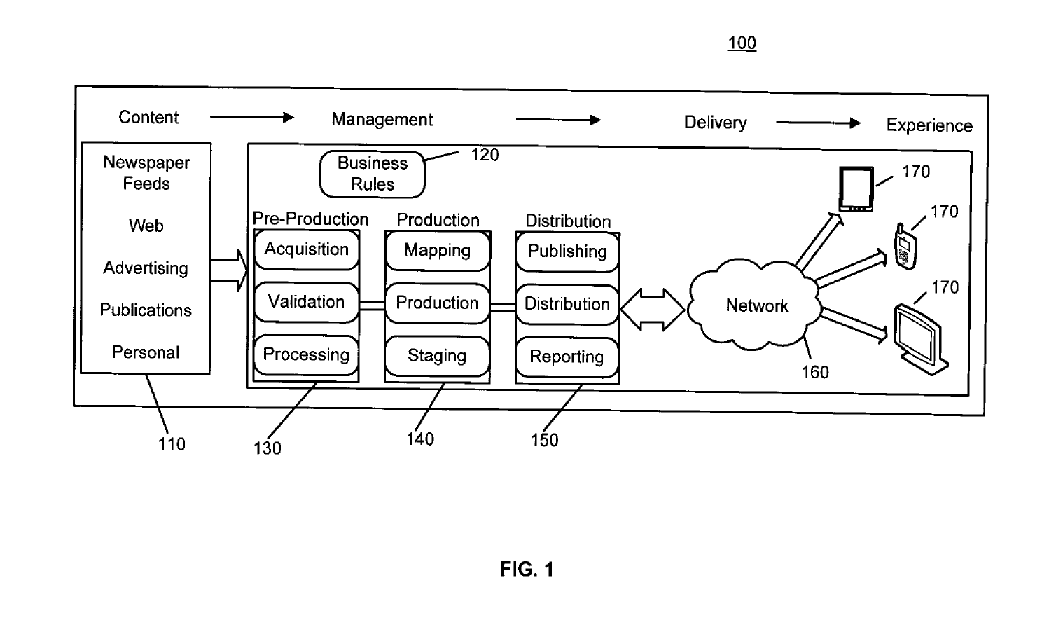

FIG. 1 depicts a block diagram of a system for content distribution, according to an exemplary embodiment. In some embodiments, the system 100 may by a content distribution system (CDN), which may include a content management system 110, a business rules system 120, a pre-production system 130, a production system 140, a distribution system 150 and one or more electronic devices 170. The distribution system 150 may distribute content to the one or more electronic devices 170 over a communications network 160. The communications network 160 may be any wired or wireless network. In one embodiment, the communication network may be an Internet Protocol (IP)-based network.

The content management system 110 may be communicatively coupled to the pre-production system 130, which in turn may be communicatively coupled to the production system 140. The production system 140 may be communicatively coupled to the distribution system 150. In some embodiments, content may be aggregated at the content management system 110 and outputted to the pre-production system 130 for validation or processing. The processed content may then be outputted from the pre-production system 130 and received at the production system 140 for mapping or staging. The mapped and staged content may then be outputted from the production system 140 and received at the distribution system 150 for publishing or distribution to the one or more electronic devices 170 over the communications network 160.

The pre-production system 130 may receive sourced content from the content management system 110 and output processed content to the production system 140. The production system 140 may received the processed content and output staged content to the distribution system 150. The distribution system 150 may receive the staged content and output approved content to one or more of the electronic devices 170.

The content management system 110 may include logic for gathering, aggregating, managing or storing content of various types. The types of content may include newspaper feeds, web content, advertising, publications, or personal information. In some embodiments, the content management system 110 may be configured to gather or aggregate content from one or more sources, categories, or content partners to the CDN 100 that provide content in association with the CDN 100. In some embodiments, the content may be gathered or aggregated automatically. In other embodiments, the content management system 110 may gather or aggregate the content based on one or more criteria. The criteria may include whether the content is perishable, curated, on-line, personal or other criteria.

The business rules system 120 may include a workflow engine configured to manage or execute modeled business processes. Each step in the operation of the workflow engine may be indicative of one or more business rules. The workflow engine may perform one or more actions based on the one or more business rules indicative of a specific template associated with a feed or publication in which content is received at the content management system 110. For example, in some embodiments, the one or more business rules may be completed for each article, publication, or advertisement processed through the workflow engine. In various embodiments, the business rules system 120 may include a workflow engine that operates according to one or more of the following rules: content enters the system through the feed; content is stored in a content repository, such as the content management system 110; various validation rules may be executed on the content; various pre-production rules are executed, the results of which may be stored back in the content management system 110; various production rules are executed, the results of which may be stored back in the content management system 110; the distribution system 150 may receive the results of the production system and distribute to electronic devices 170. In one embodiment, the CDN 100 may operate according to an amalgamation of the one or more business rules 120 as applied through the workflow engine.

Information relating to displayed content or related user actions may also be used by the business rules system 120 or other modules associated with electronic content distribution to enhance content delivery and presentment.

Exemplary content distribution networks are disclosed in U.S. application Ser. No. 12/248,482, titled “Systems, Methods and Apparatus for Content Distribution,” filed on Oct. 9, 2008 and U.S. provisional application No. 60/978,748, titled “Content Distribution and Preloading,” filed on Oct. 9, 2007, both of which are hereby incorporated by reference in their entireties.

It should be appreciated that the components/systems of the CDN 100 may be servers, network storage devices or other devices communicatively coupled to the communication network 160. In one or more embodiments, components/systems of the CDN 100 may perform any, or a combination, of storing, receiving, transmitting, producing, aggregating, or uploading electronic content. The components/systems of the CDN 100 may also perform other electronic content management functionality including, but not limited to, any, or a combination, of account management, electronic payment processing and verification, target marketing of electronic content to electronic display device users, user electronic content tracking, and content distribution.

In some embodiments, the components/systems of the CDN 100 may contain or be communicatively coupled to storage, such as a redundant array of inexpensive disks (RAID), a storage area network (SAN), an internet small computer systems interface (iSCSI) SAN, a Fibre Channel SAN, a common Internet File System (CIFS), network attached storage (NAS), a network file system (NFS), tape drive based storage, or other computer accessible storage.

Additionally, components/systems of the CDN 100 may communicate with any, or a combination, of other systems, applications, and storage locations directly via one or more of an Application Programming Interface (API), a Remote Procedure Call (RPC), an interface table, a web service, an Extensible Markup Language (XML) based interface, a Simple Object Access Protocol (SOAP) based interface, a common request broker architecture (CORBA) based interface, and other interfaces for sending or receiving information. For example, components/systems of the CDN 100 may communicate with accounting systems, marketing systems, interactive voice response (IVR) systems, systems of content providers, or other systems, servers, or components to facilitate electronic content caching and transactions.

Components/systems of the CDN 100 may each be responsible for different functionality in an electronic content distribution network. By way of non-limiting example, the components/systems of the CDN 100 may produce, receive, organize and aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user or third-party input (e.g., blogs, newsletters, etc.). Such content may be input via, by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (OCR) processes. Other scanning processes may produce electronic content without performing OCR processes. The components/systems of the CDN 100 may translate content from one format to another. For example, The components/systems of the CDN 100 may receive content from a subscriber and may translate the content into one or more electronic formats including, but not limited to, proprietary formats utilized by one or more e-book readers. The components/systems of the CDN 100 may receive subscriber or user content via emails, FTP (File Transfer Protocol), HTTP (Hyper Text Transfer Protocol), text message (e.g., via Short Message Service (SMS)), Multi-Media Messaging Service (MMS), Wireless Access Protocol (WAP), or via other electronic communication protocols. Categorization of content by the components/systems of the CDN 100 may include any, or a combination, of organizing content, storing content, and indexing content by one or more of a subject, subscription, and access. By way of non-limiting example, content may be grouped or stored in databases or other storage which may be separated according to subscription.

The network 160 may be any network, such as a local area network (LAN), a wide area network (WAN), a service provider network, the Internet, or other similar network. In some embodiments, the network 160 may be a service provider network. It should be appreciated that the network may use electric, electromagnetic, or optical signals that carry digital data streams.

The one or more electronic devices 170 may be electronic book (e-book) readers or E-Ink® devices. In other embodiments, the one or more electronic devices 170 may be desktop computers, laptops/notebooks, servers or server-like systems, modules, Personal Digital Assistants (PDAs), smart phones, cellular phones, mobile phones, satellite phones, MP3 players, video players, personal media players, personal video recorders (PVR), watches, gaming consoles/devices, navigation devices, televisions, printers, or other devices capable of receiving or transmitting signals or displaying electronic content. It should be appreciated that the network element 102 may be mobile, handheld, or stationary. It should also be appreciated that the one or more electronic devices 170 may be used independently or may be used as an integrated component in another device or system.

In some embodiments, electronic display devices 170 may access electronic content locally via one or more device interfaces. For example, the one or more electronic devices 170 may transmit and receive data to and from network 160 utilizing a standard telecommunications protocol or a standard networking protocol. By way of non-limiting example, one embodiment may utilize FTP (File Transfer Protocol), HTTP (Hyper Text Transfer Protocol), Wireless Application Protocol (WAP), Multimedia Messaging Service (MMS), Enhanced Messaging Service (EMS), Short Message Service (SMS), Global System for Mobile Communications (GSM) based systems, Transmission Control Protocol/Internet (TCP/IP) Protocols, or other protocols or systems suitable for transmitting and receiving electronic content data. Electronic content may be transmitted and received wirelessly or may utilize cabled network or telecom connections such as an Ethernet RJ45/Category 5 connection, a fiber connection, a traditional phone wireline connection, a cable connection or other wired network connection. The one or more electronic devices 170 may use standard wireless protocols including IEEE 802.11 and 802.16. The one or more electronic devices 170 may also be connected to network 102 via protocols for a wired connection, such as an IEEE Ethernet 802.3. In some embodiments, the electronic display devices 170 may utilize cellular data, SMS, voice, and Wi-Fi networks, as well as VOID or similar connections or approaches for placing a voice call over a data network.

By way of non-limiting example, the one or more electronic devices 170 may also contain one or more interfaces including a USB (Universal Serial Bus) connection, an RS-232 or serial connection, a Bluetooth connection, an RFID (Radio Frequency IDentification) reader or interrogator, an RFID tag (active or passive), a firewire connection, or interfaces supporting storage media (e.g., flash memory cards, CDs, DVDs). Electronic content may be received by an end user on electronic storage media and may be loaded onto or accessed by an electronic display device via one or more interfaces.

It should also be appreciated that while the components/systems of the CDN 100 are shown as separate components, these may be combined into greater or lesser components to optimize flexibility. For example, while the content management system 110, pre-production system 130, production system 140, and distribution system 150 are depicted as separate components/systems, it should be appreciated that these components/systems may be integrated into a single component. Other various embodiments may also be realized.

It should be appreciated that each of the components/systems of the CDN 100 may be physical or virtual servers, modules, storage, devices, systems, etc. Each of the components/systems of the CDN 100 may also communicate with each other via one or more network communications. Other various embodiments may also be provided.

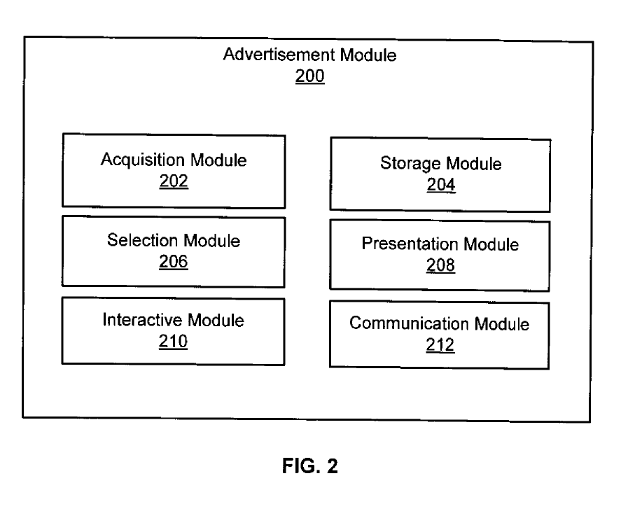

FIG. 2 depicts a module for presenting interactive content at an electronic device, according to an exemplary embodiment. The module may be an advertisement module 200. The advertisement module 200 may be a part of the content management system 110, the pre-production system 130, the production system 140, the distribution system 150, or the one or more electronic devices of the CDN 100. The advertisement module 200 may implemented in hardware, software, or a combination thereof.

The advertisement module 200 may include a variety of other components/modules, such as an acquisition module 202, a storage module 204, a selection module 206, a presentation module 208, an interactive module 210, a communication module 212, or other module. The acquisition module 202 may receive a plurality of electronic content (e.g., electronic advertisement content) from one or more content sources. The storage module 204 may store the received electronic content. The selection module 206 may select at least some of the plurality of electronic content for presentation. The presentation module 208 may present the selected electronic content at an electronic device, wherein the electronic content may be associated with contact information of at least one contact. The interactive module 210 may receive at least one user command from an input at the electronic device. The communication module 212 may establish communication between the electronic device and the at least one contact regarding the presented electronic content.

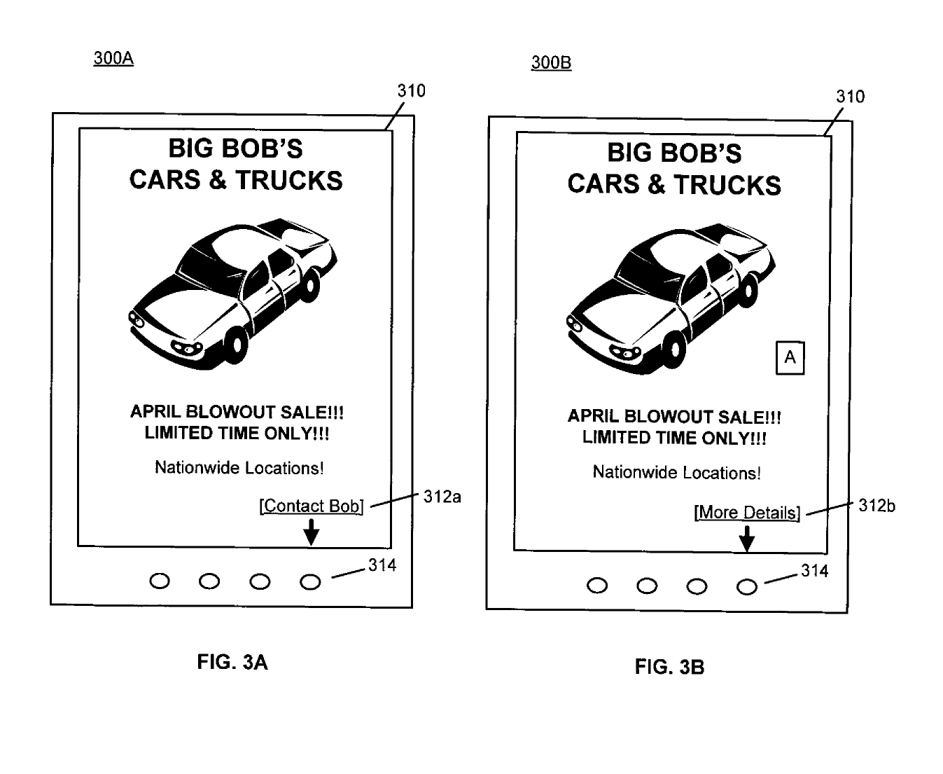

FIG. 3A-3B depict content presentment configurations with interactive electronic content at an electronic device, according to exemplary embodiments. For example, FIG. 3A depicts an interactive electronic content configuration 300A of an electronic device 170 (e.g., an electronic reader device) with an advertisement 310 for “Big Bob's Cars & Trucks” on its display. In this embodiment, the electronic advertisement content 310 may be presented within an entire display 310 of the electronic device 170. It should be appreciated that in other embodiments, the advertisement 310 may be displayed using a portion of the display.

The advertisement 310 may have several components, such as a title, text, graphics, or other content that occupies a predetermined amount of space on the display. The advertisement 310 may remain persistent (unchanging) for a duration of the displayed screen. The advertisement 310 may also include an interactive component, such as a hyperlink or other interactive component 312a. In FIG. 3A, the interactive component 312a may be a link for a user of the electronic device 170 to “Contact Bob.” In some embodiments, a user may interact with the advertisement and contact the advertiser (e.g., “Bob”) via the electronic device 170 by pushing the corresponding button 314. In other embodiments, the user may touch the screen if the electronic device has a touchscreen input. Other various user commands may be used and a variety of inputs may also be provided.

FIG. 3B depicts an interactive electronic content configuration 300B of an electronic device 170 (e.g., an electronic reader device) with an advertisement 310 for “Big Bob's Cars & Trucks” on its display. Similar to FIG. 3A above, a user may interact with the advertisement and contact the advertiser (e.g., “Bob”) via the electronic device 170 by pushing the corresponding button 314. In other embodiments, the user may touch the screen if the electronic device has a touchscreen input. Other various user commands may be used and a variety of inputs may also be provided. However, in this embodiment, the interactive component 312b may be a link for a user of the electronic device 170 to acquire “more details” regarding the advertisement 310, which may include information associated with the advertiser or the advertisement itself.

While only one advertisement 310 is depicted in configurations 300A and 300B, it should be appreciated that one or more additional electronic advertisement content may also be displayed on the same page. Moreover, the advertisement may be viewed concurrently with other non-advertisement content.

Although statistical correlations exist between advertisement placement, size, and/or design and reader/consumer behavior and odds that an advertisement to be viewed by a consumer may be increased, a viewer may still forget the contents of a non-interactive advertisement. Therefore, by providing communication with an advertiser via the electronic device, the viewer of the presented advertisement may immediately and/or directly acquire the advertised product or service being advertised. This provides a more convenient way for consumers to respond to advertisements and thereby increase marketing power and sales.

It should be appreciated that the electronic advertisement content 310 may also include hyperlinks or other interactivity option for a user to interact. For example, a user may click/touch a hyperlink to retrieve more information about the advertisement. Another example, a user interact with the electronic advertisement content 310 by physically printing out a coupon from a printer communicatively coupled to the electronic device. Other various embodiments to preserve or replicate traditionally presented advertisement content may also be provided.

Although presentment of these electronic advertisements, as described above, do not depend on general topic/subject a particular user chooses to read/consume, acquiring information relating to displayed electronic content may be used to enhance size, placement, or associated costs of advertisements. For example, when electronic content (e.g., an advertisement) is displayed at an electronic device, information relating to the displayed content may be acquired. The information may include time of day/week/year of display, duration of display, geographical location(s) of electronic device during display, location of displayed electronic content on a screen, number of times displayed, or any related user actions to the displayed content. It should be appreciated that the related user actions may include clicking a hyperlink, calling the advertiser if device is suitably equipped for making calls, bookmarking the advertisement, forwarding the advertisement to one or more friends, printing the advertisement, etc. This information may be used to determine habits/trends of a user, for example, which may be used to further determine its effectiveness or associated price/cost. In some embodiments, this information may be stored and processed by the advertisement module 200 to determine what advertisements to display and how/where to present them.

By presenting advertisements with capability to directly communicated with the electronic content provider, a more effective marketing and business solution may be provided by appealing to consumer convenience for instant gratification and shortened attention span. For example, for a potential consumer to respond to an advertisement using a traditional method (e.g., pick up another mobile communication device) may be too cumbersome for the consumer. In addition to the benefits described above, embodiments of the system and method for providing communication between a user of the electronic device and a contact associated with the electronic content not only provide an effective and improved technique for offering and selling products, but also may allow advertisers to more effectively service the consumer pool without any additional work. Moreover, advantages in business and marketing strategies may also become increasingly apparent. These benefits and opportunities may not otherwise be provided by conventional advertising techniques in electronic devices.

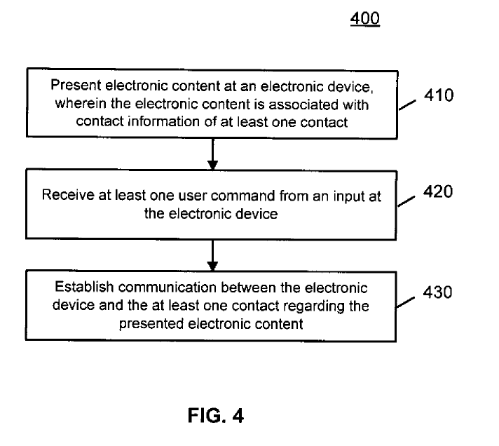

FIG. 4 depicts an illustrative flowchart for presenting interactive electronic content at an electronic device, according to an exemplary embodiment. The exemplary method 400 is provided by way of example, as there are a variety of ways to carry out methods disclosed herein. The method 400 shown in FIG. 4 may be executed or otherwise performed by one or a combination of various systems. The method 400 is described below as carried out by at least system 100 in FIG. 1, by way of example, and various elements of system 100 are referenced in explaining the example method of FIG. 4. Each block shown in FIG. 4 represents one or more processes, methods, or subroutines carried in the exemplary method 400. A computer readable media comprising code to perform the acts of the method 400 may also be provided. Referring to FIG. 4, the exemplary method 400 may begin at block 410.

At block 410, the presentation module 208 may be configured to present electronic content at an electronic device. In some embodiments, the electronic content may be associated with contact information of at least one contact. The contact information may comprises an email address, phone number, fax number, Internet Protocol (IP) address, Uniform Resource Locator (URL), or a combination thereof. The contact may comprise at least an advertiser, a sales agent, a customer service agent, server associated with the electronic content, or other contact. In some embodiments, the electronic content may comprise advertisement content. In some embodiments, the electronic device may be an electronic reader device.

At block 420, the interactive module 210 may be configured to receive at least one user command from an input at the electronic device. The input may be a button input, a scroller input, a touchscreen input, a microphone input, an external input, or other input. The external input may comprise a mouse, a keyboard, a controller, a wireless device, or other external input. It should be appreciated that the electronic content may be stored for short term or long term in the storage module 204.

At block 430, the communication module 212 may be configured to establish communication between the electronic device and the at least one contact regarding the presented electronic content. The communication may be established for acquiring a product or service associated with the electronic content. The communication may be established for acquiring more information regarding a product or service associated with the electronic content. The communication module 212 may establish direct communication between the electronic device and the at least one contact. The communication may be bidirectional, meaning communication may be established or initiated by the at least one contact associated to the presented electronic content.

It should be appreciated that when an electronic device may not be connected to a network for communication, an alternative process for presenting interactive electronic content at an electronic device may be provided. For example, an electronic device may be out of range of a network, have networking disabled (e.g., in the air on an airplane), or have insufficient battery charge to power one or more communication portions of the electronic device. In these exemplary scenarios, a user of the electronic device may not be able to contact the advertiser directly using the electronic device, as described above. However, the electronic device may be equipped with the ability to fulfill a request to contact the advertiser once the electronic device is back in networking range, recharged, etc. When the user requests a “instant gratification moment” (e.g., pushing a input on the electronic device corresponding to action for communicating with the content provider) at a time when the electronic device is unable to communicate and fulfill the request, the electronic device may be configured to alert the user once the device is back in networking ranged, recharged, etc. In some embodiments, the electronic device may alert or prompt the user that the electronic device may proceed with transmitting the request. In other embodiments, the electronic device may automatically proceed with transmitting the request and contact the advertiser. In other embodiments, the electronic device may automatically proceed with transmitting the request and contact the advertiser for the advertiser to contact the user at the electronic device or other contact information associated with the user.

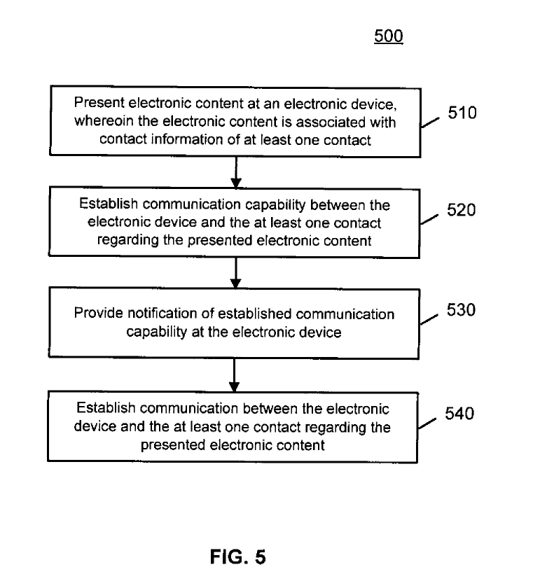

FIG. 5 depicts an illustrative flowchart for presenting interactive electronic content at an electronic device, according to an exemplary embodiment. The exemplary method 500 is provided by way of example, as there are a variety of ways to carry out methods disclosed herein. The method 500 shown in FIG. 5 may be executed or otherwise performed by one or a combination of various systems. The method 500 is described below as carried out by at least system 100 in FIG. 1, by way of example, and various elements of system 100 are referenced in explaining the example method of FIG. 5. Each block shown in FIG. 5 represents one or more processes, methods, or subroutines carried in the exemplary method 500. A computer readable media comprising code to perform the acts of the method 500 may also be provided. Referring to FIG. 5, the exemplary method 500 may begin at block 510.

At block 410, the presentation module 208 may be configured to present electronic content at an electronic device. In some embodiments, the electronic content may be associated with contact information of at least one contact. The contact information may comprises an email address, phone number, fax number, Internet Protocol (IP) address, Uniform Resource Locator (URL), or a combination thereof. The contact may comprise at least an advertiser, a sales agent, a customer service agent, server associated with the electronic content, or other contact. In some embodiments, the electronic content may comprise advertisement content. In some embodiments, the electronic device may be an electronic reader device.

At block 420, the communication module 212 may be configured to detected communication capability between the electronic device and the at least one contact regarding the presented electronic content.

At block 430, the presentation module 208, interactive module 210, or communication module 212 may be configured to provide one or more notifications or alerts that communication capability at the electronic device has been established.

At block 440, the communication module 212 may be configured to establish communication between the electronic device and the at least one contact regarding the presented electronic content. The communication may be established for acquiring a product or service associated with the electronic content. The communication may be established for acquiring more information regarding a product or service associated with the electronic content. The communication module 212 may establish direct communication between the electronic device and the at least one contact. The communication may be bidirectional, meaning communication may be established or initiated by the at least one contact associated to the presented electronic content.

In other embodiments, the electronic device may be equipped with location-detection capability, such as Global Positioning Systems (GPS) or other means (e.g., network-tower identification), so that the electronic device may be alert the user that an opportunity to fulfill an earlier request currently exists based on the location of the electronic device. This may be particularly important if an advertisement the user wanted to interact with, but could not because network communication was not available, is now available and the location of the device in a proximity to the location of the advertiser.

In other embodiments, the electronic device may be equipped with time-detection capability, such as clock device or other means, so that the electronic device may be alert the user that an opportunity to fulfill an earlier request currently exists based on the time or expiration of the advertisement. This may be particularly important if an advertisement the user wanted to interact with, but could not because network communication was not available, was time-sensitive or had an expiration date/time and without an alert or reminder to the user at the electronic device, the advertisement opportunity may pass.

It should be appreciated that while embodiments are directed to at least one spatially and temporally persistent component and at least one spatially and temporally transient component, other various embodiments may also be provided. For example, the advertisement may include a spatially transient and temporally persistent or a spatially persistent and temporally transient component. Other various embodiments may also be provided.

While the features and functionalities of the systems and methods are primarily directed to electronic advertisements, it should be appreciated that the features and functionalities of may be applied to other content as well. Furthermore, while the advertisement content is described primarily in a visual display, it should be appreciated that the content may include multimedia, audio, or other presentments.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system for establish communication between an electronic device and at least one contact associated with electronic content presented at the electronic device, comprising:
a presentation module configured to present electronic content at an electronic device, wherein the electronic content is associated with contact information of at least one contact;
an interactive module configured to receive at least one user command from an input at the electronic device; and
a communication module configured to establish communication between the electronic device and the at least one contact regarding the presented electronic content.

2. The system of claim 1, wherein the electronic content comprises advertisement content.

3. The system of claim 2, wherein the communication is established for acquiring a product or service associated with the electronic content.

4. The system of claim 2, wherein the communication is established for acquiring more information regarding a product or service associated with the electronic content.

5. The system of claim 1, wherein the electronic device is an electronic reader device.

6. The system of claim 1, wherein the contact information comprises at least one of an email address, phone number, fax number, Internet Protocol (IP) address, and Uniform Resource Locator (URL).

7. The system of claim 1, wherein the contact comprises at least an advertiser, a sales agent, a customer service agent, and server associated with the electronic content.

8. The system of claim 1, wherein the input comprises at least one of a button input, a scroller input, a touchscreen input, a microphone input, and an external input.

9. The system of claim 8, wherein the external input is a mouse, a keyboard, a controller, or a wireless device.

10. The system of claim 1, wherein the communication module establishes direct communication between the electronic device and the at least one contact.

11. A method for establish communication between an electronic device and at least one contact associated with electronic content presented at the electronic device, comprising:
present, at a presentation module, electronic content at an electronic device, wherein the electronic content is associated with contact information of at least one contact;
receive, at an interactive module, at least one user command from an input at the electronic device; and
establish, at a communication module, communication between the electronic device and the at least one contact regarding the presented electronic content.

12. The method of claim 11, wherein the electronic content comprises advertisement content.

13. The method of claim 12, wherein the communication is established for acquiring a product or service associated with the electronic content.

14. The method of claim 12, wherein the communication is established for acquiring more information regarding a product or service associated with the electronic content.

15. The method of claim 11, wherein the electronic device is an electronic reader device.

16. The method of claim 11, wherein the contact information comprises at least one of an email address, phone number, fax number, Internet Protocol (IP) address, and Uniform Resource Locator (URL).

17. The method of claim 11, wherein the contact comprises at least an advertiser, a sales agent, a customer service agent, and server associated with the electronic content.

18. The method of claim 11, wherein the input comprises at least one of a button input, a scroller input, a touchscreen input, a microphone input, and an external input.

19. The method of claim 18, wherein the external input is a mouse, a keyboard, a controller, or a wireless device.

20. The method of claim 11, wherein the communication module establishes direct communication between the electronic device and the at least one contact.

21. A computer readable medium comprising code to perform the acts of the method of claim 11.
